(19) United States
(12) Patent Application Publication
(10) Pub. No.: US 2011/0144810 A1
(43) Pub. Date: Jun. 16, 2011

(54) ELEVATOR AND BUILDING POWER SYSTEM WITH SECONDARY POWER SUPPLY MANAGEMENT

(75) Inventors: John P. Wesson, Vernon, CT (US); Mauro J. Atalla, south Glastonbury, CT (US); Stella M. Oggianu, Manchester, CT (US); William A. Veronesi, Hartford, CT (US)

(73) Assignee: OTIS ELEVATOR COMPANY, Farmington, CT (US)

(21) Appl. No.: 13/059,093

(22) PCT Filed: Aug. 15, 2008
(86) PCT No.: PCT/US08/09781

§ 371 Date: Feb. 15, 2011

(51) Int. Cl. G05D 17/02

(52) U.S. Cl. 700/275; 700/295

(57) ABSTRACT

A system (10) manages power from a secondary power (30) source to supply power to elevator and building systems (18) after failure of a primary power source (20). An available power monitor provides a measure or estimate (such as state-of-charge) of the power available from the secondary power source. A demand monitoring system (46) generates a signal related to passenger demand for each elevator in the elevator system. A controller (34) then prioritizes allocation of power from the secondary power source to the elevator and building systems based on the available power from the secondary power source and the passenger demand in the elevator system.

### BACKGROUND

The present invention relates to power systems. More specifically, the present invention relates to a power system for managing power from a secondary power supply to elevator and building electrical systems.

An elevator drive system is typically designed to operate over a specific input voltage range from a power supply. The components of the drive have voltage and current ratings that allow the drive to continuously operate while the power supply remains within the designated input voltage range. However, in certain markets the utility network is less reliable, and utility voltage sags, voltage surges, brownout conditions (i.e., voltage conditions below the tolerance band of the drive), and/or power loss conditions are prevalent.

When a power sag or power loss occurs, the elevator may become stalled between floors in the elevator hoistway until the power supply returns to the nominal operating voltage range. In conventional systems, passengers in the elevator may be trapped until a maintenance worker is able to release a brake for controlling cab movement upwardly or downwardly to allow the elevator to move to the closest floor. More recently, elevator systems employing automatic rescue operation have been introduced. These elevator systems include electrical energy storage devices that are controlled after power failure to provide power to move the elevator to the next floor for passenger disembarkation. However, many current automatic rescue operation systems are complex and expensive to implement, and may provide unreliable power to the elevator drive after a power failure. In addition, these systems often fail to provide power for building lighting and control systems, communication systems, and heating, ventilation, and air conditioning systems that are needed for basic rescue or evacuation capabilities.

### SUMMARY

The present invention relates to a system for managing power from a secondary power source to supply power to elevator and building systems after failure of a primary power source. An available power monitor provides an indication of power available from the secondary power source. A demand monitoring system generates a signal related to passenger demand for each elevator in the elevator system. A controller then prioritizes allocation of power from the secondary power source to the elevator and building systems based on the power available from the secondary power source and the passenger demand in the elevator system.

### BRIEF DESCRIPTION OF THE DRAWINGS

FIG. 1 is a schematic view of a power system for driving elevator and building electrical systems during normal and power failure conditions.

FIG. 2 is a flow diagram of a process for managing power from a secondary power supply to supply power to elevator and building electrical systems after a power failure.

### DETAILED DESCRIPTION

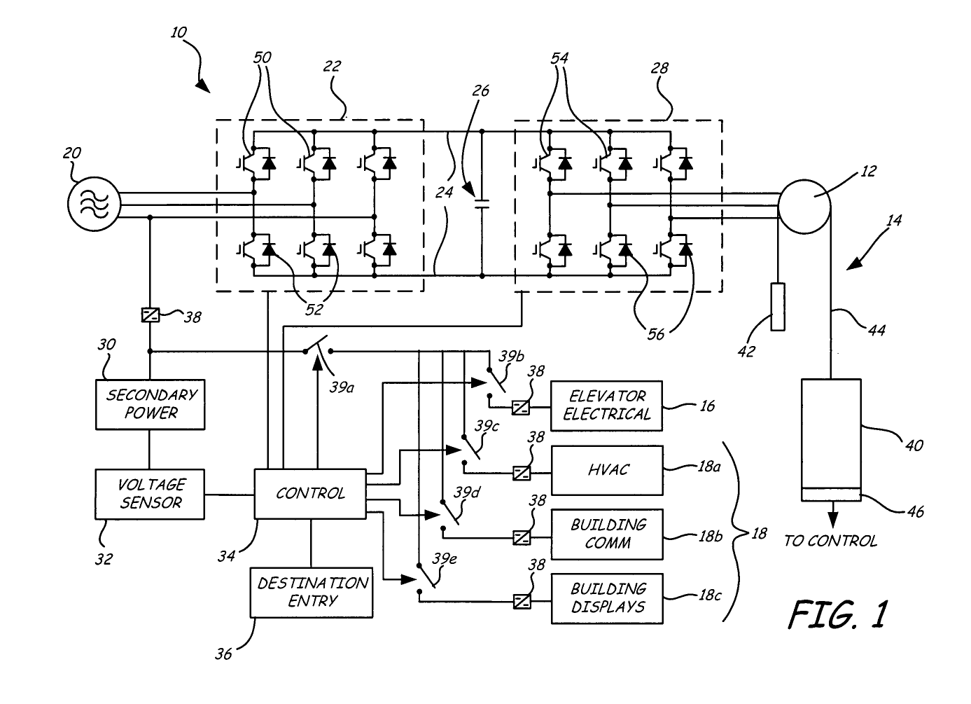

FIG. 1 is a schematic view of power system 10 for driving hoist motor 12 of elevator 14, elevator electrical system 16, and building electrical systems 18. Elevator electrical system 16 may include elevator lighting and control electrical systems, for example. Heating, ventilation, and air conditioning (HVAC) system 18a, building communications system 18b (e.g., loud speakers), and building information display systems 18c are shown as examples of building electrical systems 18. Power system 10 also includes primary power supply 20, power converter 22, power bus 24, smoothing capacitor 26, power inverter 28, power failure sensor 29, secondary power supply 30, available power monitor 32, control block 34, destination entry system 36, destination entry input devices 37a, video sensors 37b, power converters 38, and switches 39a, 39b, 39c, 39d, and 39e. Primary power supply 20 may be an electrical utility, such as a commercial power source. Secondary power supply 30 may be a building back-up power source, such as a generator, or a renewable power source, such as rechargeable batteries, that is initiated in the event of failure of primary power supply 20. Elevator 14 includes elevator car 40 and counterweight 42 that are connected through roping 44 to hoist motor 12. Load weight sensor 46 is configured to provide a signal related to the weight of the load in elevator car 40 to control block 34.

As will be described herein, power system 10 is configured to drive hoist motor 12, elevator electrical systems 16, and building electrical systems 18 when power from primary power supply 20 is insufficient. For example, in certain markets the utility network is less reliable, where persistent utility voltage sags or brownout conditions (i.e., voltage conditions below the tolerance band of the drive) are prevalent. Power system 10 according to the present invention allows for continuous operation of hoist motor 12, elevator electrical systems 16, and building electrical systems 18 during these periods of irregularity. Power system 10 manages power from secondary power supply 30 to provide extended operation of elevator and building systems after a power failure or during brownout conditions.

Power converter 22 and power inverter 28 are connected by power bus 24. Smoothing capacitor 26 is connected across power bus 24. Primary power supply 20 provides electrical power to power converter 22. Power converter 22 is a three-phase power inverter that is operable to convert three-phase AC power from primary power supply 20 to DC power. In one embodiment, power converter 22 comprises a plurality of power transistor circuits including parallel-connected transistors 50 and diodes 52. Each transistor 50 may be, for example, an insulated gate bipolar transistor (IGBT). The controlled electrode (i.e., gate or base) of each transistor 50 is connected to control block 34. Control block 34 controls the power transistor circuits to convert the three-phase AC power from primary power supply 20 to DC output power. The DC output power is provided by power converter 22 on power bus 24. Smoothing capacitor 26 smoothes the rectified power provided by power converter 22 on DC power bus 24. It is important to note that while primary power supply 20 and secondary power supply 30 are shown as three-phase AC power supplies, power system 10 may be adapted to receive power from any type of power source, including (but not limited to) a single phase AC power source and a DC power source.

The power transistor circuits of power converter 22 also allow power on power bus 24 to be inverted and provided to primary power supply 20 and/or secondary power supply 30. In one embodiment, control block 34 employs pulse width modulation (PWM) to produce gating pulses so as to periodically switch transistors 50 of power converter 22 to provide a three-phase AC power signal to primary power supply 20. In another embodiment, control block 34 operates transistors 50 to provide DC power to secondary power supply 30. This regenerative configuration reduces the demand on primary power supply 20 and/or allows recharging of secondary power supply 30.

Power inverter 28 is a three-phase power inverter that is operable to invert DC power from power bus 24 to three-phase AC power. Power inverter 28 comprises a plurality of power transistor circuits including parallel-connected transistors 54 and diodes 56. Each transistor 54 may be, for example, an insulated gate bipolar transistor (IGBT). The controlled electrode (i.e., gate or base) of each transistor 54 is connected to control block 34. Control block 34 controls the power transistor circuits to invert the DC power on power bus 24 to three-phase AC output power. The three-phase AC power at the outputs of power inverter 28 is provided to hoist motor 12. In one embodiment, control block 34 employs PWM to produce gating pulses to periodically switch transistors 54 of power inverter 28 to provide a three-phase AC power signal to hoist motor 12. Control block 34 may vary the speed and direction of movement of elevator 14 by adjusting the frequency and magnitude of the gating pulses to transistors 54.

In addition, the power transistor circuits of power inverter 54 are operable to rectify power that is generated when elevator 14 drives hoist motor 12. For example, if hoist motor 12 is generating power, control block 34 controls transistors 54 in power inverter 28 to allow the generated power to be converted and provided to DC power bus 24. Smoothing capacitor 26 smoothes the converted power provided by power inverter 28 on power bus 24.

Hoist motor 12 controls the speed and direction of movement between elevator car 40 and counterweight 42. The power required to drive hoist motor 12 varies with the acceleration and direction of elevator 14, as well as the load in elevator car 40. For example, if elevator car 40 is being accelerated, run up with a load greater than the weight of counterweight 42 (i.e., heavy load), or run down with a load less than the weight of counterweight 42 (i.e., light load), a maximal amount of power is required to drive hoist motor 12. If elevator 14 is leveling or running at a fixed speed with a balanced load, it may be using a lesser amount of power. If elevator car 40 is being decelerated, running down with a heavy load, or running up with a light load, elevator car 40 drives hoist motor 12. In this case, hoist motor 12 generates three-phase AC power that is converted to DC power by power inverter 28 under the control of control block 34. The converted DC power may be returned to primary power supply 20, returned to secondary power supply 30, and/or dissipated in a dynamic brake resistor connected across power bus 24.

It should be noted that while a single hoist motor 12 is shown connected to power system 10, power system 10 can be modified to power multiple hoist motors 12. For example, a plurality of power inverters 28 may be connected in parallel across power bus 24 to provide power to a plurality of hoist motors 12. In addition, it should be noted that while secondary power supply is shown connected to one phase of the three phase input of power converter 22, secondary power source 30 may alternatively be connected to DC power bus 24.

When primary power supply 20 is incapable of supplying sufficient power to drive hoist motor 12, elevator electrical system 16, and building electrical system 18, such as due to a power failure or a scheduled or unscheduled brownout, secondary power supply 30 provides power to drive these systems. Power failure sensor 29 senses complete power failure and brownout conditions and signals control 34, which allocates power from secondary power source 30 to hoist motor 12, elevator electrical system 16 and building electrical system 18.

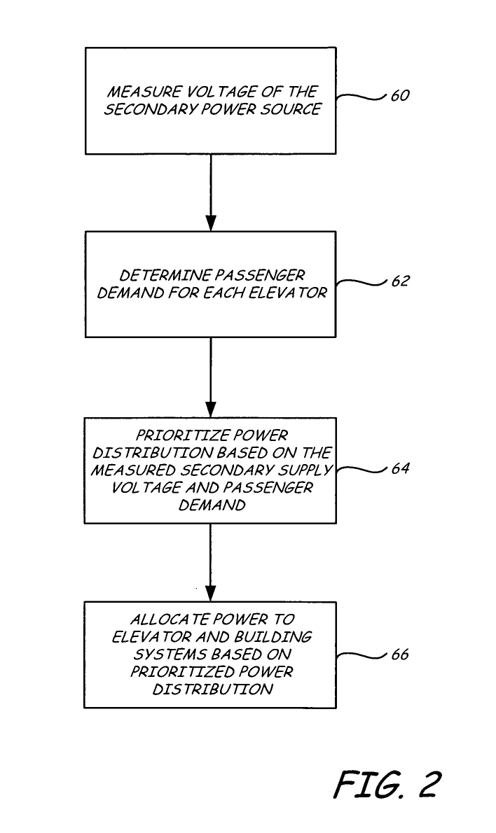

FIG. 2 is a flow diagram of a process for managing power from secondary power supply 30 to supply power to hoist motor 12, elevator electrical system 16, and building electrical system 18 and building systems after failure of primary power supply 20. The voltage of the secondary power supply 30 is measured by voltage sensor 32 (step 60). A signal related to the power available from secondary power supply 30 is provided by available power monitor 32 to control block 34. When secondary power supply 30 is an electrical energy storage system (such as batteries or super capacitors), the available power signal may be an estimate of state of charge (SOC) based upon sensed voltage, one or more of current, and temperature of secondary power supply 30.

In embodiments in which secondary power supply 30 stores mechanical energy (such as a flywheel system), available power monitor 32 may provide a signal based on stored mechanical energy. In embodiments in which secondary power supply 30 is a fuel based generator, the signal from available power monitor 32 may be a function of fuel remaining.

Control block 34 also determines the passenger demand for each elevator to establish the number of passengers using or waiting to use the elevator system after the power failure (step 62). In some embodiments, control block 34 receives a signal from load weight sensor 46 related to the weight of the load in elevator car 40. Control block 34 can then use this weight measurement to estimate the number of passengers in elevator car 40. The weight measurement can also be used to establish whether there are any passengers in elevator car 40 when the power failure occurs. Control block 34 may then determine how much power is going to be needed from secondary power supply 30 to service remaining demand in the elevator system.

In other embodiments, control block 34 receives information from destination entry system 36 related to passenger demand in the elevator system, including the number of passengers in elevator car 40 and the number of passengers waiting to board elevator car 40. Destination entry system 36 may service the single elevator car 40 shown, but typically is used in conjunction with a multiple elevator system. In destination entry system 36, passengers enter their desired destination floors on destination entry input devices 37a provided on each floor level in the building. In addition, video sensors 37b may provide input to destination entry system 36 of the number of passengers waiting for service at each floor. Each passenger is then assigned to an elevator car 40 that will most efficiently service his or her destination request. The elevator stops at those floors that passengers on the assigned elevator requested, and those floors that the assigned elevator has been committed to pick up additional passengers. Control block 34 may use this assignment information to help determine how much power is going to be needed from secondary power supply 30 to service remaining demand in the elevator system.

Control block 34 then prioritizes power distribution from secondary power supply 30 based on the measured voltage of secondary power supply 30 and passenger demand (step 64). The power use from secondary power supply 30 is prioritized such that elevator and building electrical systems are powered to efficiently, quickly, and safely service of passenger demand or, in emergency situations, evacuate passengers from the building. The electrical systems in power system 10 include hoist motor 12, elevator electrical system 16, HVAC system 18a, building communications system 18b, and building information display system 18c. Control block 34 may set minimal emergency building functions, such as power to drive hoist motor 12 and minimal lighting in elevator electrical system 16, at the highest priority in the event of a power failure. Control block 34 may set other electrical systems (or subsystems thereof) at lower priority levels based on their criticality to satisfying passenger demand and to building safety. These priority levels may be based on the voltage of secondary power supply 30 such that, as the energy of secondary power supply 30 is depleted, power is disconnected from the lowest priority electrical systems first, with the highest priority electrical systems being the last to be disconnected. By extending operation of elevator electrical systems 16, HVAC system 18a, building communication system 18b, and building informational displays 18c as long as possible, information regarding the power failure can be more readily conveyed to occupants of the building and passengers in elevator car 40. This allows occupants of the building to remain informed and, in the event of an emergency, allows the building occupants to more efficiently and expeditiously evacuate the building.

Control block 34 may also adjust the power distribution priority levels from secondary power supply 30 based on existing conditions in the building and elevator systems. For example, if signals from load weight sensor 40 and/or destination entry system 36 indicate that there is remaining passenger demand to be serviced after the power failure, providing power to hoist motor 12 and elevator electrical systems 16 (e.g., elevator lighting, elevator communications, etc.) may take priority over providing power to other systems that are not as critical to servicing passenger demand, such as HVAC system 18a or building displays 18c. After all passenger demand has been serviced, control block may re-prioritize the power distribution priority levels such that HVAC system 18a, building communications system 18b, and building displays 18c have a higher priority than power for elevator electrical system 16 and hoist motor 12. In this way, the prioritization of power distribution in control block 16 is dynamic since the priority levels may change as building conditions change.

A combination of signals from load weight sensor 46 and destination entry system 36 may also be used to assure all passenger demand assigned to elevator car 40 is serviced while efficiently using the power from secondary power supply 30. For example, as described above, if elevator car 40 is being decelerated, running down with a heavy load, or running up with a light load, elevator car 40 drives hoist motor 12. Thus, control block 34 can control the number of passengers assigned to elevator car 40 through destination entry system 36 to maximize the number of elevator runs cause hoist motor 12 to regenerate power. This allows power that typically is dedicated to drive hoist motor 12 to be available to power other elevator and building electrical systems. Consequently, control block 34 may re-prioritize building electrical systems 18 to a higher priority while hoist motor is regenerating power. In addition, the regenerated power can be converted and returned to secondary power supply 30 to extend operation of the elevator and building electrical systems after a power failure, and to avoid draining the battery past the point where the start of additional regenerative runs would be possible.

Control block 34 then allocates power to hoist motor 12, elevator electrical system 16, and building electrical systems 18 based on the prioritized power distribution (step 66). In the embodiment shown in FIG. 1, control block 34 is configured to provide signals to switches 39a, 39b, 39c, 39d, and 39e. Switches 39a-39e may be any type of power control device that facilitates controllable connection between two nodes, including transistors, mechanical switches, or DC/DC converters. Control block 34 controls the state of switches 39a-39e to connect elevator electrical system 16 and building electrical systems 18 to secondary power supply 30 based on the priority levels of the various systems and the measured voltage of secondary power supply 30. Switches 39a-39e may simply turn power on or off, or may be capable of adjusting the amount of power delivered. Each switch 39a-39e may be a single switching device, or may be multiple devices so that power can be directed to selected individual components or subsystems of elevator electrical system 16 and building electrical systems 18.

Appropriately sized DC/DC power converters 38 are connected between secondary power supply 30 and each electrical system to step up or step down the voltage from secondary power supply 30 to the level appropriate for the system. For example, if the measured voltage of secondary power supply 30 and priority levels are such that power is to only be distributed to hoist motor 12 and elevator electrical system 16, control block 34 closes switches 39a and 39b to connect elevator electrical system 16 to secondary power supply 30, and operates converter 22 and inverter 24 to supply three-phase power to hoist motor 12. As another example, if all passenger demand has been serviced, control block 34 may close switches 39a, 39c, 39d, and 39e and open switch 39b to connect secondary power supply 30 to building electrical systems 18 to facilitate evacuation of the building.

During a building evacuation with a power outage, upward traveling empty elevator cars generate power and downward traveling cars with more than 50% of payload also generate power. If evacuations can be managed to take advantage of this, after accounting for energy losses, available power from secondary power source 30 can be extended when compared to random operation with energy producing and energy consuming runs. Therefore, control 34 may force operation of elevator 14 into a pattern where passenger traffic is encouraged (by voice or display guides associated with destination entry input devices 37a) to travel downward and exit the building. Evacuation would start at the top of the building and move downward. Sensors 37b on floors near landings detect passengers and the load sensor 46 in car 40 determine if car 40 is empty or light.

In summary, the present invention relates to a system for managing power from a secondary power source to supply power to elevator and building systems after failure of a primary power source. An available power monitor determines the power available from the secondary power source. A demand monitoring system generates a signal related to passenger demand for each elevator in the elevator system. A controller then prioritizes allocation of power from the secondary power source to the elevator and building systems based on the available power from the secondary power source and the passenger demand in the elevator system. By managing the power from the secondary power source, enhanced and extended rescue, emergency, or evacuation elevator services and capabilities may be provided. In addition, power from the secondary power source may be used to power key emergency features in the building external to the elevator system, as well as elevator and building lighting and informational displays. These additional capabilities can be crucial to efficiently and effectively servicing remaining passenger demand in the elevator system after a power failure or brownout.

Although the present invention has been described with reference to preferred embodiments, workers skilled in the art will recognize that changes may be made in form and detail without departing from the spirit and scope of the invention.

1. A system for managing power from a secondary power source to supply power to elevator and building systems after failure of a primary power source, the system comprising:
an available power monitor operable to provide an indication of power available from the secondary power source;
a demand monitoring system operable to generate a signal related to passenger demand for each elevator in the elevator system; and
a controller configured to prioritize allocation of power from the secondary power source to the elevator and building systems based on the indication of power available from the secondary power source and the passenger demand in the elevator system.

2. The system of claim 1, wherein the demand monitoring system comprises a load sensor associated with each elevator that is operable to measure elevator load weight.

3. The system of claim 2, wherein movement of each elevator is controlled by a hoist motor, and wherein the controller is further configured to allow an elevator to run if the elevator load weight is sufficient to cause the hoist motor to regenerate power that is supplied to the secondary power source.

4. The system of claim 1, wherein, when the indication of power available from the secondary power source is below a threshold, the controller minimizes power supplied from the secondary power source to the building system and allocates power to the elevator system to service remaining passenger demand.

5. The system of claim 1, wherein the demand monitoring system comprises a destination entry system that tracks the demand assigned to each elevator.

6. The system of claim 2, wherein the demand monitoring system provides a signal based upon an estimation of the number of passengers waiting on each floor.

7. The system of claim 1, and further comprising:
a plurality of power control devices each connected between the secondary power source and a component of the building systems to control power delivered from the secondary power source to the component, wherein the controller is further operable to control the plurality of power control devices based on the indication of power available from the secondary power source and the passenger demand in the elevator system.

8. The system of claim 1, wherein the secondary power source comprises an energy storage system.

9. The system of claim 8, wherein the energy storage system comprises an electrical energy storage system, and wherein the indication of power available comprises a state-of-charge signal.

10. The system of claim 1, and further comprising:
a passenger alert system for providing status information related to the power failure.

11. The system of claim 10, wherein the passenger alert system provides instructions to occupants of a building for evacuation of the building using the elevator system powered by the secondary power source.

12. A method for managing power from a secondary power source to supply power to elevator and building systems after failure of a primary power source, the method comprising:
determining power available from the secondary power source;
determining passenger demand for each elevator in the elevator system;
prioritizing power distribution to the elevator and building systems from the secondary power source based on the determined power available from the secondary power source and the passenger demand in the elevator system; and
allocating power to the elevator and building systems based on the prioritized power distribution.

13. The method of claim 12, wherein determining passenger demand for each elevator comprises measuring elevator load weight for each elevator.

14. The method of claim 13, and further comprising:
allowing an elevator to run if the elevator load weight is sufficient to cause the hoist motor associated with the elevator to regenerate power; and
supplying the regenerated power to the secondary power source.

15. The method of claim 12, wherein prioritizing power distribution to the elevator and building systems comprises:
determining whether the power available from the secondary power source is below a threshold; and
prioritizing power supplied to the elevator system higher than power supplied to the building system to service remaining passenger demand if the power available from the secondary power source is below the threshold.

16. The method of claim 12, wherein the allocating step comprises controlling power control devices that are each connected between the secondary power source and components of the elevator and building systems based on the prioritized power distribution.

17. The method of claim 12, wherein the secondary power source comprises an electrical energy storage system, and determining power available comprises estimating state-of-charge of the electrical energy storage system.

18. A system for managing power from a secondary power source to supply power to elevator and building systems after failure of a primary power source, wherein the elevator system comprises one or more elevators each associated with a hoist motor, the system comprising:
a regenerative drive for delivering power from the secondary power supply to the hoist motor;
an available power monitor operable to determine power available from the secondary power source;
a demand monitoring system operable to generate a signal related to passenger demand for each elevator in the elevator system; and
a controller configured to prioritize allocation of power from the secondary power source to the elevator and building systems based on the power available from the secondary power source and the passenger demand in the elevator system.

19. The system of claim 18, wherein the demand monitoring system comprises a load sensor associated with each elevator that is operable to measure elevator load weight.

20. The system of claim 19, wherein movement of each elevator is controlled by a hoist motor, and wherein the controller is further configured to allow an elevator to run if the elevator load weight is sufficient to cause the hoist motor to regenerate power that is supplied to the secondary power source.

21. The system of claim 18, wherein, when the power available from the secondary power source is below a threshold, the controller allocates sufficient power to the one or more hoist motors to service remaining passenger demand by reducing power supplied to at leas one of the building systems.

22. The system of claim 18, wherein the demand monitoring system comprises a destination entry system that tracks the demand assigned to each elevator.

23. The system of claim 18, and further comprising:
a plurality of power control devices each connected between the secondary power source and a component of the building systems, wherein the controller is further operable to control the plurality of power control devices based on the power available from the secondary power source and the passenger demand in the elevator system.

24. The system of claim 18, wherein the secondary power source comprises an electrical energy storage system.

25. The system of claim 24, wherein the available power monitor produces a state-of-charge estimate of the electrical energy storage system as a measure of power available.

26. The system of claim 18, and further comprising:
a passenger alert system for providing status information related to the power failure.

27. The system of claim 26, wherein the passenger alert system provides instructions to occupants of a building for evacuation of the building using the elevator system powered by the secondary power source.

28. The system of claim 18, wherein the regenerative drive comprises:
a converter to convert alternating current (AC) power from the main power supply into direct current (DC) power;
an inverter to drive the hoist motor by converting the DC power from the converter into AC power and, when the hoist motor is generating, to convert AC power produced by the hoist motor to DC power; and
a power bus connected between the converter and the inverter to receive DC power from the converter and the inverter.
